(19) United States
(12) Patent Application Publication
(10) Pub. No.: US 2008/0227523 A1
(43) Pub. Date: Sep. 18, 2008

(54) Wagering Game and Method Including a Multi-Step Ladder Feature

(75) Inventors: John Vallejo, Henderson, NV (US); Keith Rucker, Las Vegas, NV (US)

Correspondence Address: BALLY GAMING INC., 6601 S. BERMUDA ROAD, LAS VEGAS, NV, 89119, US

(73) Assignee: Bally Gaming, Inc., Las Vegas, NV (US)

(21) Appl. No.: 11/935,293

(22) Filed: Nov. 5, 2007

Related U.S. Application Data
(60) Provisional application No. 60/865,637, filed on Nov. 13, 2006.

(51) Int. Cl. A63F 13/00; A63F 9/24

(52) U.S. Cl. 463/20; 463/25

(57) ABSTRACT

Wagering games, gaming machines, gaming systems and associated methods are disclosed that include a multi-step ladder feature. One disclosed aspect provides that an indicator be positioned on a ladder or scale when like indicia are displayed by the game. Another disclosed aspect provides that an award be paid based on the position of the indicator at the end of the game.

### RELATED APPLICATIONS

This application claims priority from provisional application 60/865,637 filed on Nov. 13, 2006.

This application is also related to U.S. patent application 11/nnn,nnn entitled “GAMING MACHINE AND METHOD INCLUDING A MULTI-STEP LADDER FEATURE,” filed on Nov. 5, 2007 which claims priority from provisional application 60/865,637 filed on Nov. 13, 2006.

This application is also related to U.S. patent application 11/nnn,nnn entitled “NETWORKED GAMING SYSTEM AND METHOD INCLUDING A MULTI-STEP LADDER FEATURE,” filed on Nov. 5, 2007 which claims priority from provisional application 60/865,637 filed on Nov. 13, 2006.

All of the above referenced applications are hereby incorporated by reference in their entireties for all purposes.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

1. Field of the Invention

The present invention is directed to wagering games and methods and, more particularly, to wagering games and methods that have a matching game with ladder feature.

2. Description of the Related Art

In the prior art, various types of gaming machines have been developed with different features to captivate and maintain player interest. In general, a gaming machine allows a player to play a game in exchange for a wager. Depending on the outcome of the game, the player may be entitled to an award which is paid to the player by the gaming machine, normally in the form of currency or game credits. Gaming machines may include flashing displays, lighted displays, or sound effects to capture a player's interest in a gaming device.

Another important feature of maintaining player interest in a gaming machine includes providing the player with many opportunities to win awards, such as cash or prizes. For example, in some slot machines, the display windows show more than one adjacent symbol on each reel, thereby allowing for multiple-line betting. Some gaming machines offer a player the opportunity to win millions of dollars by providing progressive jackpots. Additionally, feature games of various types have been employed to reward players above the amounts normally awarded on a standard game pay schedule. Generally, such feature games are triggered by predetermined events such as one or more appearances of certain combinations of indicia in a primary game. In order to stimulate interest, feature games are typically set to occur at a gaming machine on a statistical cycle based upon the number of primary game plays. The Millionaire Sevens game on the S6000 slot machine by Bally Gaming, Inc. is one example of a slot machine with a feature game comprising a “top box” simulating a ladder. A plurality of possible awards are displayed on the ladder. When a triggering outcome occurs on the slot machine, awards on the ladder are sequentially illuminated, starting at the bottom, until an award which has been randomly selected for winning is illuminated, at which time the feature game concludes and the player is paid. One drawback to the Millionaire Sevens game is that the feature game concludes rapidly without building a sense of player suspense or anticipation based on intermediate outcomes of the feature game.

While gaming machines including such feature games have been very successful, there remains a need for games that provide a player with enhanced excitement and increased opportunity of winning.

### SUMMARY OF THE INVENTION

In accordance with one or more embodiments of the present invention, a wagering game and method include a first game comprising a set of game plays and a second game comprising a plurality of second game plays, the second game occurring after a triggering event and comprising a plurality of displayed indicia. The second game includes a scale or ladder comprising graduated values corresponding to potential awards and an indicator which may adjust along the scale as a result of matching like indicia during the second game plays. An award is paid to the player based on the value on the scale indicated by the indicator at the conclusion of the second game.

In accordance with a second embodiment of the present invention, a method of operating a game includes the steps of accepting a wager from a player and initiating play of the first game according to the wager. The method further includes the steps of, upon a triggering event associated with the game, initiating play of the second game and determining one or more second game outcomes. Indicia corresponding to each second game outcome are displayed and an indicator adjusts along a scaled set of potential awards as a result of matching like displayed indicia. An award based on the position of the indicator at the conclusion of the second game is paid to the player.

Other features and advantages will become apparent from the following detailed description, taken in conjunction with the accompanying drawings, which illustrate by way of example, the features of the various embodiments.

### BRIEF DESCRIPTION OF THE DRAWINGS

FIG. 1 provides an overview of an example game of one or more embodiments of the invention.

FIG. 2 is an example display image associated with a help screen of or more embodiments of the invention.

FIG. 3 is an example image of feature displays associated with one or more embodiments of the invention.

FIG. 4 is an example functional block diagram depicting the steps associated with carrying out a method in accordance of one or more aspects of the invention.

FIG. 5 is a perspective view of an example gaming machine in accordance with one or more aspects of the present invention.

FIG. 6 is a block diagram of the physical and logical components of an example motherboard as may be implemented within the gaming machine of FIG. 5.

FIG. 7 is an example schematic block diagram showing the hardware elements of a networked gaming system in accordance with one or more aspects of the present invention.

### DETAILED DESCRIPTION OF THE INVENTION

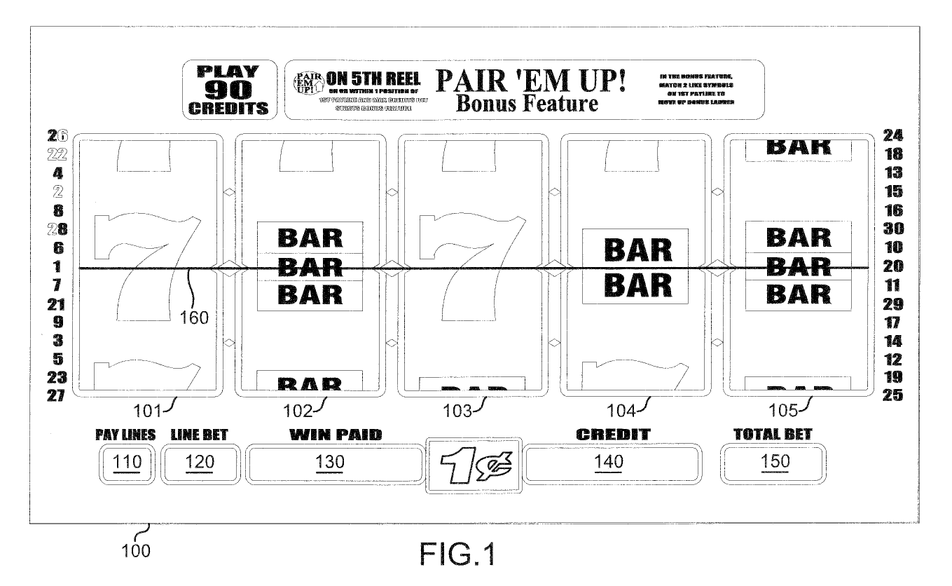

Various embodiments are directed to a game and method for playing a game, wherein the game includes a matching game with ladder component. Embodiments of the game and method are illustrated and described herein, by way of example only, and not by way of limitation. Referring now to the drawings, and more particularly to FIGS. 1-7, there are shown illustrative examples of a game and associated method in accordance with various aspects of the invention.

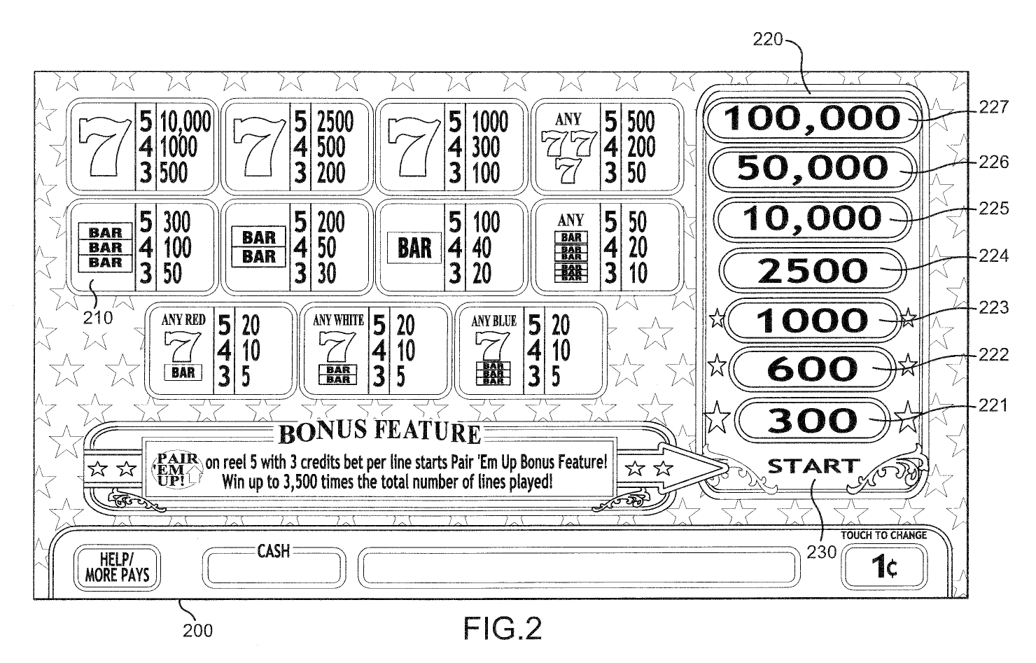

With reference to FIGS. 1 and 2, in accordance with one embodiment of the invention, the Pair 'Em Up feature game provides the player five free spins of reels 101-105. It will be appreciated that the number of reel spins may vary based on the rules of a particular embodiment, including, for example, a number of spins randomly selected during game play. As shown on the right side of FIG. 2, from a starting position 230, an indicator advances along a scale (or ladder) 220 displaying a set of graduated potential awards. The indicator moving one position upward along scale 220 for every two or three like symbols that appear on the first pay line 160 during a single free game; in other words, when the random outcome of the game pairs up like symbols. Similarly, the player advances two positions up the ladder for every four or five like symbols that appear on the first pay line 160 during a single free game. A PAIR'EM UP symbol appearing on the first pay line 160 also advances the player one position on the ladder. In some embodiments, certain pairs of symbols may cause the indicator to move to a lower position on the ladder. During free games, the first pay line is the only active pay line and is used for the purpose of identifying like symbols and the PAIR'EM UP symbol only. Standard pays according to the pay table are not available during the feature game. Blank spaces are not considered eligible for pairing. A maximum of three position advances on the ladder are possible with each spin. At the conclusion of the five free game set, or when the top of ladder 220 is reached, the value associated with the current ladder level 221-227 is awarded to the player and the five free game counter is reset and the ladder pointer aligned with a starting position 230. If no qualifying matches occur during the five free games, the player is awarded a consolation prize. In one embodiment, pairing of certain symbols may terminate the feature before the predetermined number of free spins has been exhausted. The number of free games allotted to the feature game may vary. In embodiment, the value associated with the current ladder level 221-227 is scaled based on the size of the player's wager. In another embodiment, one or more special symbols, such a joker symbol, may cause the player's position on the ladder to move to a less favorable position (i.e. move backwards or down one or more positions on the ladder).

As shown in FIG. 2, the indicator may by example be comprised of illuminated stars on the outside of each rung of the ladder or may simply be an illumination of the value associated with the rung on the ladder indicating the level achieved by the player at the particular state of game play. Additional examples of indicators are further discussed below and/or shown in the accompanying drawings.

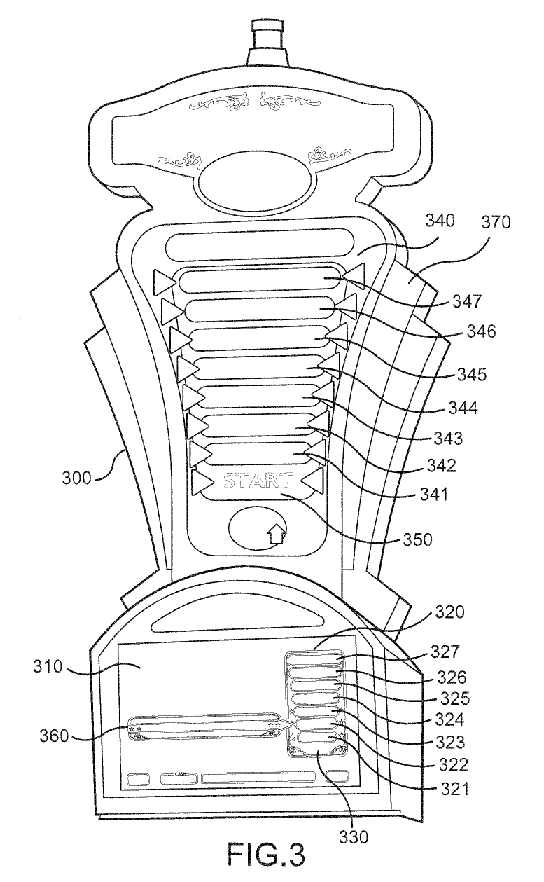

Turning to FIG. 3, in accordance with one embodiment of the invention, a top box 300 provides a large representation of a feature scale 340. As the current position of pointer 360 changes on video display 310 to indicate starting position 330 or one of awards 321-327 on feature scale 330, a corresponding start location 350 or award 341-347 is illuminated on feature scale 340. The large display allows bystanders to readily observe the outcome of the feature game. It may have additional flashing lights 370 in the form of, for example, incandescent lamps or light emitting diodes to attract players' attention to the slot machine. These features may entice patrons to play an adjacent unoccupied machine. While the scales shown in FIGS. 2 and 3 are vertical in orientation, a horizontal display or any other orientation of the award scale may be implemented within the scope of the various embodiments of the invention. For example, a horizontal “slider” may be used. Similarly, as shown, the indicator may be a separate indicator adjacent to the ladder (as in pointer 360). As shown on pointer 360, during play of the feature game, the pointer may include a duplicate set of reels reflecting the outcome on reels 101-105. Paired-symbols may be highlighted on the duplicate set of reels, or other embellishments may be added. Such a moving indicator may also be simulated on a video display associated with the game or, in one embodiment, an electromechanical moving pointer 360 includes a video display such as a color liquid crystal display, on which the duplicate set of reels or other enhancements, such as a progressive amount, may be displayed. In some embodiments, a separate moving indicator may be replaced by an indicator incorporated into the ladder itself such that the “current position” is indicated in some way such as, but not limited to, illuminating the current award position in a manner different from the illumination of all other awards, for example, by flashing.

Referring back to FIG. 1, the Pair'Em Up primary game 100 is implemented using five spinning reels 101-105. Each of 30 pay line patterns (all not shown) passes through one indicium on each of the five reels. For example, the first pay line 160 extends horizontally through the center position of each of the five reels 101-105. The number of pay lines and their patterns are by way of example only and may vary. The player selects the number of played pay lines and the number of credits or coins wagered on each line using touch screen controls or gaming device control buttons. The player's selections are displayed on PAY LINES meter 110, LINE BET meter 120 and TOTAL BET meter 130 located adjacent to the reels. WIN PAID meter 140 and CREDIT meter 150 provide the player with information about the amount paid by the last game played and the total number of credits available for play. The player may collect the balance of his credits by pressing a COLLECT button (not shown).

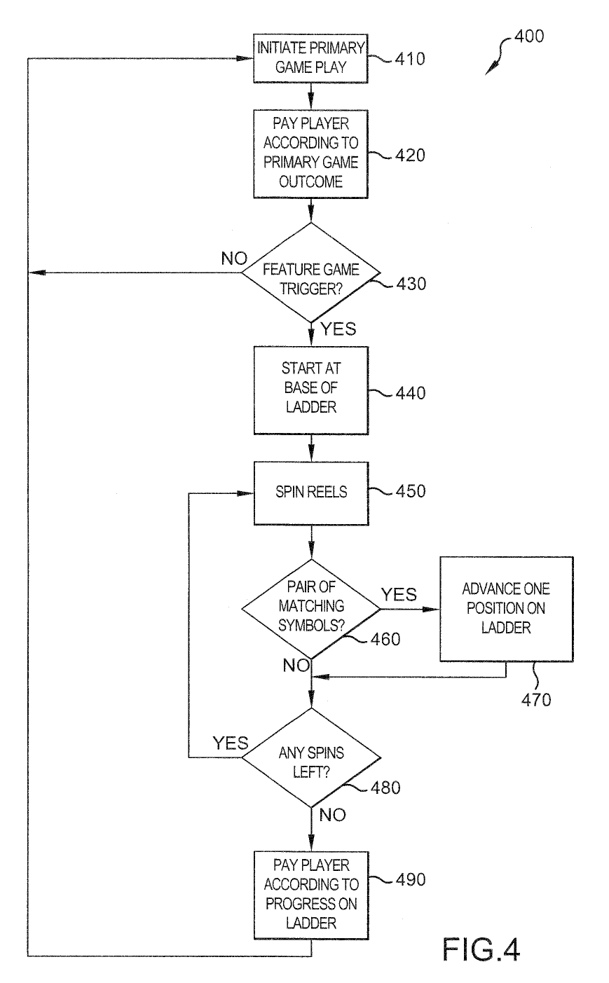

The player initiates game play by pressing a SPIN button (not shown). In some embodiments, the player may simultaneously select all pay lines at the maximum number of coins or credits allowed per line by pressing a MAX BET button. Buttons (see FIG. 4, 460) on gaming machine 400 (FIG. 4) or touch screen buttons (not shown) may be used to perform the actions described here without deviating from the scope of the invention. Reels 101-105 are made to spin and stop in their predetermined stop positions and then indicate whether the stop positions of the reels resulted in a winning game outcome.

As shown on FIG. 2, in accordance with one embodiment of the invention, winning outcomes may be indicated on a pay table. In accordance with one embodiment, part of a pay table 200 is shown in FIG. 2. The pay table may be accessible through a HELP/PAYS or similar button. In alternate embodiments, the pay table may be presented on a second video or printed display attached to the gaming device (i.e. display 453 or “pay glass” 452, FIG. 4). A winning combination, for example, could be three or more symbols adjacent to one another on an active pay line. For each winning combination, the game device awards the player the award in the pay table, adjusted as necessary based on the number of credits wagered on the pay line on which the win occurred. For example, three BAR-BAR-BAR symbols 210 adjacent to one another from left-to-right on an active pay line would pay 50 times the player's wager. In some embodiments, video representations of pay tables may factor in the amount of the player's wager and no additional award adjustment is required.

In various embodiments, winning combinations may be evaluated across adjacent reels from left-to-right, from right-to-left or both. Additional winning combinations may be awarded when certain indicia do not necessarily accumulate adjacently on a pay line, but rather, appear anywhere on the reels (i.e., “scatter pays”). In addition, “wild” indicia may be used to complete winning combinations. Some “wild” indicia may also cause completed winning combinations to be result in pay amounts in excess of the normal winning combination by way of multiplication or addition, for example, a wild doubler symbol may be used.

Various primary game outcomes may be utilized to trigger the play of the feature game, including, but not limited to, awarding bonus play when certain symbols appear on a pay line, when certain symbols are scattered, when no symbols of a certain type appear, when a certain winning combination occurs or, regardless of the visible symbols, at random or fixed intervals. In the Pair'Em Up embodiment, the appearance of a PAIR'EM UP trigger symbol on reel 105 triggers the feature game. In one embodiment, a wager of a certain amount may also be required in order to trigger the feature game. For example, the player may be required to play the maximum wager in order to be eligible.

A logical flow diagram generally depicting the steps associated with a method 400 for carrying out a game having a matching game with ladder component, in accordance with one aspect of the invention, is presented in FIG. 4. The order of actions as shown in FIG. 4 is only illustrative, and should not be considered limiting. For example, the order of the actions may be changed, additional steps may be added or some steps may be removed without deviating from the scope and spirit of the invention.

First at block 410, primary game play is initiated. The player places a wager and starts the game, whereby each reel then spins or displays a representation of a slot machine reel spin before stopping with particular indicia displayed to the player. A win occurs if a series of indicia (BAR, BAR, BAR, for example) appears on one or more pay lines or scattered, as described above. The player is paid for any winning symbol combinations at block 420. At block 430, the indicia on the reels are examined to determine the existence of a combination predetermined to be a feature game trigger. For example, a PAIR'EM UP symbol appearing on one of the reels may be considered a feature game trigger. If the displayed indicia do not correspond to a feature game trigger, processing resumes at block 410 with play of another iteration of the primary game. Otherwise, the feature game is played at blocks 440-490.

At block 440, an indicator is set at the base of the ladder and a free game count is initialized. The count may be initialized to zero and counted up, or may be initialized to the number of free games to be played and counted down. At block 450, a random set of reel outcomes is selected and the reels are spun (or a simulated video reel spin occurs) and stopped at the preselected locations.

At block 460, a determination is made whether the symbols aligned on the first pay line include a pair of matching symbols. If so, the indicator advances one position on the ladder at block 470. Regardless of whether the indicator advanced on the ladder, it is determined at block 470 whether any free game spins remain to be performed. For example, at the start of the feature game, it may have been determined that five reel spins would be performed. It will be appreciated that the number of reel spins may vary based on the rules of a particular embodiment, including, for example, a number of spins randomly selected during game play. If all free reel spins have been performed, the feature game is complete. The player is paid according to the position of the indicator on the ladder and the next primary game play is initiated at block 410. If all reel spins have not yet been performed, processing returns to block 450 for another cycle of reel spin and potential advancement of the indicator on the ladder.

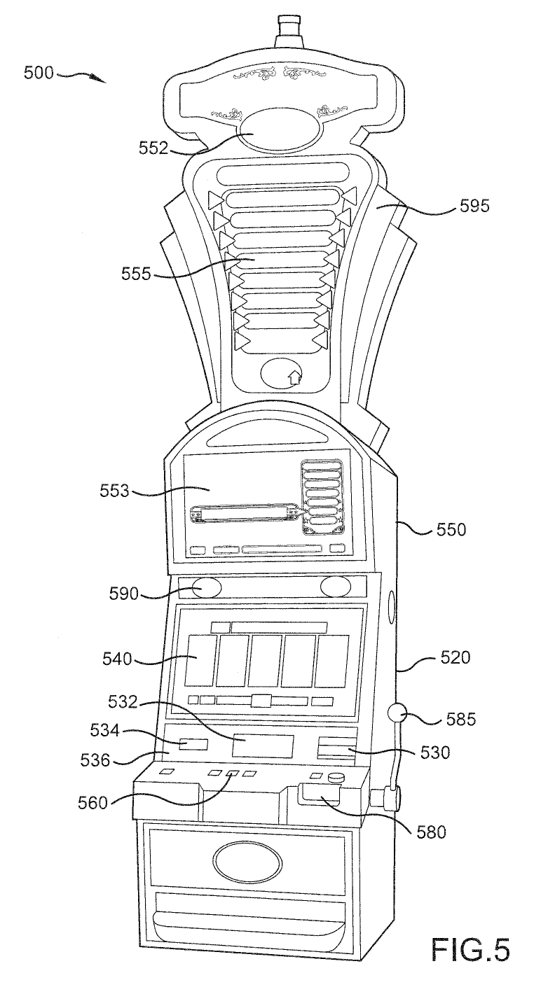

In accordance with one embodiment, FIG. 5 illustrates a gaming machine 500 including cabinet housing 520, primary game display 540, player-activated buttons 560, player tracking panel 536, bill/voucher acceptor 580 and one or more speakers 590. Cabinet housing 520 is a self-standing unit that is generally rectangular in shape and may be manufactured with reinforced steel or other rigid materials which are resistant to tampering and vandalism. Cabinet housing 520 houses a processor, circuitry, and software (not shown) for receiving signals from player-activated buttons 560, operating the games, and transmitting signals to the respective displays and speakers. Any shaped cabinet may be implemented with any embodiment of gaming machine 500 so long as it provides access to a player for playing a game. For example, cabinet 520 may comprise a slant-top, bar-top, or table-top style cabinet. The operation of gaming machine 500 is described more fully below.

The plurality of player-activated buttons 560 may be used for various functions such as, but not limited to, selecting a wager denomination, selecting a game to be played, selecting a wager amount per game, initiating a game, or cashing out money from gaming machine 500. Buttons 560 function as input mechanisms and may include mechanical buttons, electromechanical buttons or touch screen buttons. Optionally, a handle 585 may be rotated by a player to initiate a game.

In other embodiments, buttons 560 may be replaced with various other input mechanisms known in the art such as, but not limited to, a touch screen system, touch pad, track ball, mouse, switches, toggle switches, or other input means used to accept player input. For example, one input means is a universal button module as disclosed in U.S. application Ser. No. 11/106,212, entitled “Universal Button Module,” filed on Apr. 14, 2005, which is hereby incorporated by reference. Generally, the universal button module provides a dynamic button system adaptable for use with various games and capable of adjusting to gaming systems having frequent game changes. More particularly, the universal button module may be used in connection with playing a game on a gaming machine and may be used for such functions as selecting the number of credits to bet per hand.

Cabinet housing 520 may optionally include top box 550 which contains “top glass” 552 comprising advertising or payout information related to the game or games available on gaming machine 500. Player tracking panel 536 includes player tracking card reader 534 and player tracking display 532. Voucher printer 530 may be integrated into player tracking panel 536 or installed elsewhere in cabinet housing 520 or top box 550.

Game display 540 presents a game of chance wherein a player receives one or more outcomes from a set of potential outcomes. For example, one such game of chance is a slot machine game, an example of which is entitled Pair'Em Up, described above. In other aspects of the invention, gaming machine 500 may present a video or mechanical reel slot machine, a video keno game, a lottery game, a bingo game, a Class II bingo game, a roulette game, a craps game, a blackjack game, a mechanical or video representation of a wheel game or the like.

Mechanical or video/mechanical embodiments may include game displays such as mechanical reels, one or more wheels, or dice as required to present the game to the player. In video/mechanical or pure video embodiments, game display 540 is, typically, a CRT or a flat-panel display in the form of, but not limited to, liquid crystal, plasma, electroluminescent, vacuum fluorescent, field emission, or any other type of panel display known or developed in the art. Game display 540 may be mounted in either a “portrait” or “landscape” orientation and be of standard or “widescreen” dimensions (i.e., a ratio of one dimension to another of at least 16×9). For example, a widescreen display may be 32 inches wide by 18 inches tall. A widescreen display in a “portrait” orientation may be 32 inches tall by 18 inches wide. Additionally, game display 540 preferably includes a touch screen or touch glass system (not shown) and presents player interfaces such as, but not limited to, credit meter (not shown), win meter (not shown) and touch screen buttons (not shown).

Game display 540 may also present information such as, but not limited to, player information, advertisements and casino promotions, graphic displays, news and sports updates, or even offer an alternate game. This information may be generated through a host computer networked with gaming machine 500 on its own initiative or it may be obtained by request of the player using either one or more of the plurality of player-activated buttons 560; the game display itself, if game display 540 comprises a touch screen or similar technology; buttons (not shown) mounted about game display 540 which may permit selections such as those found on an ATM machine, where legends on the screen are associated with respective selecting buttons; or any player input device that offers the required functionality.

Cabinet housing 520 incorporates an electromechanical game display 540 comprising stepper motor-driven reels. However, in various embodiments, cabinet housing 520 or top box 550 may house one or more additional displays 553 or components used for various purposes including additional game play screens, animated “top glass,” progressive meters or mechanical or electromechanical devices such as, but not limited to, wheels, pointers or reels. Backlit ladder 555 is an example of an additional game display used in with the Pair'Em Up game. The additional displays may or may not include a touch screen or touch glass system. An example of a touch glass system is disclosed in U.S. Pat. No. 6,942,571, entitled “Gaming Device with Direction and Speed Control of Mechanical Reels Using Touch Screen,” which is hereby incorporated by reference.

Depending upon the occurrence of a winning outcome, a celebration sequence may be displayed on display 553 or a horn or other sounds may be emitted through speakers 590. Lights 595 may be flashed in order to develop a sense of fanfare around a winning player and to alert casino floor personnel that a large win has occurred so that they may congratulate the winner, notify the winner of the payout, pay the winner, and/or reset gaming machine 500.

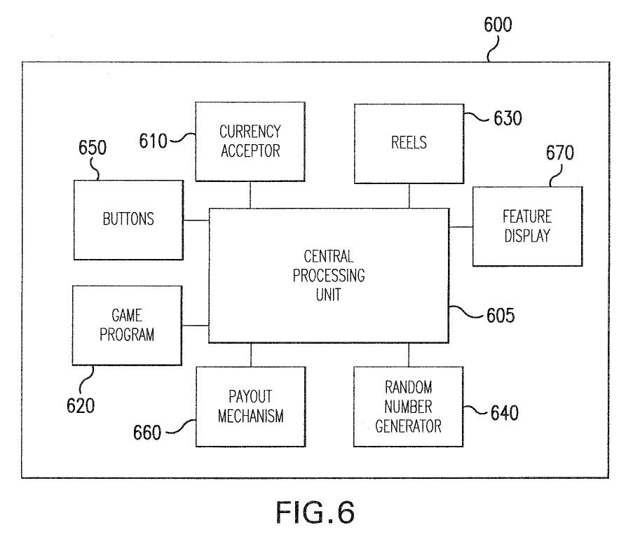

In accordance with one embodiment of the present invention, FIG. 6 is a block diagram showing the interconnection 600 of physical and logical components of gaming machine 500. Currency acceptor 610 is typically connected to a conventional central processing unit (“CPU”) 505, such as an Intel Pentium microprocessor mounted on a gaming motherboard, by a serial connection such as RS-232 or USB. The gaming motherboard may be mounted with other conventional components, such as are found on conventional personal computer motherboards, and loaded with a gaming machine operating system (OS), such as an Alpha OS installed within a Bally S9000, M9000 or CineVision™ slot machine. CPU 605 executes game program 620 that causes reels 630 to display a game. In one embodiment, game program 620 is a game entitled Pair'Em Up.

When a player has inserted a form of currency such as, for example and without limitation, paper currency, coins or tokens, cashless tickets or vouchers, electronic funds transfers or the like into currency acceptor 610, a signal is sent to CPU 605 which, in turn, assigns an appropriate number of credits for play. The player may further control the operation of the gaming machine, for example, to select the amount to wager via electromechanical or touchscreen buttons 650. The game starts in response to the player pushing one of buttons 650 or an alternate start mechanism such as a handle or touchscreen icon (not shown). Random number generator 640 responds to instructions from CPU 605 to provide a display of randomly selected indicia on reels 630. In some embodiments, random generator 640 may be physically separate from gaming machine 500; for example, it may be part of a central determination host system (not shown) which provides random game outcomes to CPU 605. Thereafter, the player may or may not interact with the game through electromechanical or touchscreen buttons 650 to change the displayed indicia. Finally, CPU 605 under control of game program 620 compares the final display of indicia to a pay table. The set of possible game outcomes may include a subset of outcomes related to the triggering of a feature game. In the event the displayed outcome is a member of this subset, CPU 605, under control of game program 620, may cause feature game play to be presented on feature display 670.

In one embodiment, reels 630 are electromechanical reels. Game program 600 includes reel spinning firmware to provide proper signals for driving multiple stepper motors (not shown), which, in turn, spin the reels 630. Preferably, the motors are driven using a “full step” excitation sequence in which a single motor step is preformed by changing the excitation on one of the two-phase inputs in a specified sequence. The sequence determines whether the direction implemented is forward or reverse. The reel drive pulse trains go through three distinct stages: acceleration, steady state, and deceleration. During acceleration, reels 630 are driven with a pulse frequency that is less than the maximum “start/stop” frequency. Typically, if a motor is attempted to be started with a high frequency pulse, the motor loses synchronization and slips. Therefore, preferably the drive frequency is incrementally increased until the steady state drive frequency is reached. At steady state, reels 630 are driven for a specified number of steps at the maximum drive frequency before going to the deceleration phase. During deceleration, the process is reversed and the drive frequency decreased until the stopping frequency is reached. Preferably, this procedure helps to prevent reels 630 from slipping past the proper stop position on deceleration. Finally, at the stopping point, the motor excitation signals are held constant.

In one embodiment, the primary game reels are not used for the feature play; instead, a wheel or other feature display 670 is used to present the feature game outcomes. The feature display may be an electromechanical device, may present the feature on a video display or both.

Predetermined payout amounts for certain outcomes, including feature game outcomes, are stored as part of game program 620. Such payout amounts are, in response to instructions from CPU 605, provided to the player in the form of coins, credits or currency via payout mechanism 660, which may be one or more of a credit meter, a coin hopper, a voucher printer, an electronic funds transfer protocol or any other payout means known or developed in the art.

In various embodiments of gaming machine 500, game program 620 is stored in a memory device (not shown) connected to or mounted on the gaming motherboard. By way of example, but not by limitation, such memory devices include external memory devices, hard drives, CD-ROMs, DVDs, and flash memory cards. In an alternative embodiment, the game programs are stored in a remote storage device. In one embodiment, the remote storage device is housed in a remote server. The gaming machine may access the remote storage device via a network connection, including but not limited to, a local area network connection, a TCP/IP connection, a wireless connection, or any other means for operatively networking components together. Optionally, other data including graphics, sound files and other media data for use with gaming machine 500 are stored in the same or a separate memory device (not shown). Some or all of game program 620 and its associated data may be loaded from one memory device into another, for example, from flash memory to random access memory (RAM).

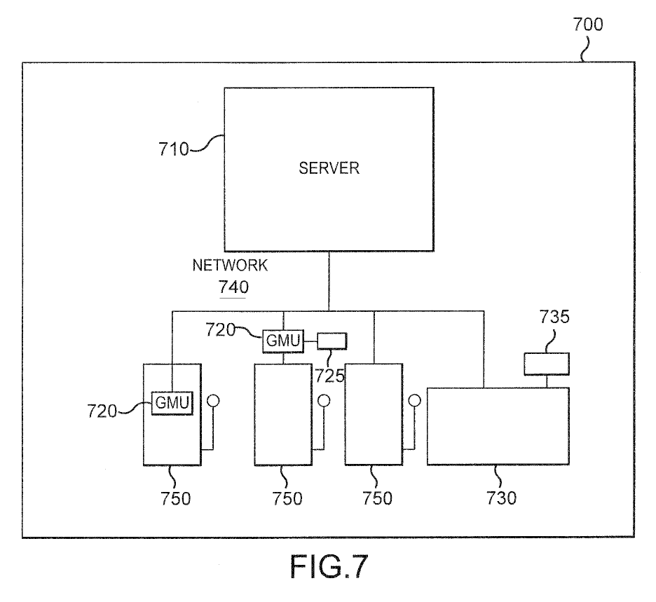

Referring to FIG. 7, in accordance with one aspect of the invention, gaming system 700 includes server 710, gaming machines 750, and network 740 connecting gaming machines 750 to server 710. Additionally, gaming display computer 730 is shown connected to network 740. Server 710 may be selected from a variety of conventionally available servers. The type of server used is generally determined by the platform and software requirements of the gaming system. Examples of suitable servers are an IBM RS6000-based server, an IBM AS/400-based server or a Microsoft Windows-based server, but it should be appreciated that any suitable server may be used. It may also be appreciated that server 710 may be configured as a single “logical” server that comprises multiple physical servers. Gaming machines 750 operate similar to conventional peripheral networked terminals. Gaming machines 750 have a player interface such as a display, a card reader, and selection buttons through which gaming machines 750 interact with a player playing a wagering game having a matching game with ladder component in accordance with various embodiments of the invention. The player interface is used for making choices such as the amount of a bet or the number of lines to bet. Gaming machines 750 also provide information to server 710 concerning activity on gaming machines 750 and provide a communication portal for players with server 710. For example, the player interface may be used for selecting different server-related menu options such as, but not limited to, transferring a specified number of credits from a player account onto the credit meter of the gaming machine, or for transferring credits from the gaming machine to a central player account.

In various embodiments, any of the gaming machines 750 may be a mechanical reel spinning slot machine, video slot machine, video poker machine, keno machine, video blackjack machine, or a gaming machine offering one or more of the above described primary games including a matching game with ladder component. Alternately, gaming machines 750 may provide a matching game with ladder component as one of a set of multiple primary games selected for play by a random number generator. Networking components (not shown) facilitate communications across network 740 between the system server 710 and game management units 720 and/or gaming display control computers 730 that control displays for carousels of gaming machines. Game management units (GMU's) 720 connect gaming machines to networking components and may be installed in the gaming machine cabinet or external to the gaming machine. The function of the GMU is similar to the function of a network interface card connected to a desktop personal computer (PC) and it may contain tracking software which provides notification to the casino of certain events on a gaming machine 750, including wins. Depending upon the casino management system, payouts on large wins at gaming machines 750 may be made directly to a player account managed by the host computer; in which case, the player is notified by way of the GMU at gaming machine 750 that the player's account has been credited.

Some GMU's have much greater capability and can perform such tasks as presenting and playing a game having a matching game with ladder component using a display 725 operatively connected to GMU 720. In one embodiment, GMU 720 is a separate component located outside the gaming machine. Alternatively, in another embodiment, the GMU 720 is located within the gaming machine. Optionally, in an alternative embodiment, one or more gaming machines 750 connect directly to the network and are not connected to a GMU 720. Displays related to games offering a matching game with ladder component on gaming machines 750 or GMU displays 725 may also be presented on gaming display 735 by gaming display control computer 730. An example of a display control computer is disclosed in U.S. application Ser. No. 11/463,793, entitled “Reconfigurable Gaming Display and System,” filed on Aug. 10, 2006, which is hereby incorporated by reference in its entirety.

A gaming system of the type described above also allows a plurality of games in accordance with the various embodiments of the invention to be linked under the control of server 710 for cooperative or competitive play in a particular area, carousel, casino or between casinos located in geographically separate areas.

One will appreciate that a gaming system may also comprise other types of components, and the above illustrations are meant only as examples and not as limitations to the types of components or games having a matching game with ladder component. Additionally, it may further be appreciated that each of the games could be operated on a remote host computer such that a player initiates play with the host computer over a network via the player interface and gaming machine 750 operates the respective gaming and video displays in conjunction with the game whose play is controlled by the remote computer.

The various embodiments described above are provided by way of illustration only and should not be construed to limit the claimed invention. For example, a game in accordance with one or more aspects of the invention may be one of a set of primary games randomly selected for play following initiation of play by the player. For example, U.S. application Ser. No. 11/428,220, entitled “Multiple Primary Games Triggered by Random Number Generator,” filed on Jun. 30, 2006, hereby incorporated in by reference its entirety, discloses a gaming machine including at least two distinct primary games. After receiving a wager, the gaming machine determines which primary game to activate. The selected primary game is activated and a game outcome is presented to the player on a game display. A payout may be awarded according to the game outcome. The availability of one or more of the games may be restricted based on the size of the wager. In another embodiment, a game in accordance with one or more aspects of the invention may be associated with a table game such a poker or blackjack. For example, a player may receive a chance to win a number of reel spins on a slot machine located adjacent the table, the opportunity based on cards or hands received during play of the table game. Each reel spin provides an opportunity to advance an indicator on a ladder with an award paid according to the final position of the indicator as described above.

Those skilled in the art will readily recognize various modifications and changes that may be made to the claimed invention without following the example embodiments and applications illustrated and described herein, and without departing from the true spirit and scope of the claimed invention, which is set forth in the following claims.

What is claimed:

1. A wagering game comprising:
a set of game outcomes associated with indicia, a plurality of the outcomes determined during a play of the game;
an award scale;
an indicator for designating an award on the award scale, wherein the indicator is positioned on the scale as a result of matching like indicia according to the plurality of determined outcomes; and
an award paid to a player based on the designated award at the conclusion of the game.

2. The game of claim 1 wherein the award scale comprises a vertical ladder.

3. The game of claim 1 wherein each of the game outcomes is randomly determined.

4. The game of claim 1 further comprising a wager, wherein play of the game is restricted by the amount of the wager.

5. The game of claim 1 further comprising a wager, wherein the award paid to the player at the conclusion of the game is scaled according to the wager.

6. A method of operating a game comprising a first game and a second game comprising:
accepting a wager from a player;
initiating play of the first game according to the wager;
upon a triggering event associated with the game, initiating play of the second game;
determining one or more second game outcomes;
displaying indicia corresponding to each second game outcome;
advancing an indicator on a scale as a result of matching like displayed indicia; and
paying an award based on the position of the indicator on the scale when predetermined conditions have been met.

7. The method of claim 6 further comprising the step of restricting play of the second game based on the amount of the wager.

8. The method of claim 6 wherein the first game comprises at least one of a slot machine game, a poker game, a keno game, a blackjack game, a bingo game, a roulette game and a wheel game.

9. The method of claim 6 wherein the predetermined conditions include having determined a certain number of second game outcomes.

10. The method of claim 6 wherein the predetermined conditions include the indicator indicating a predetermined value on the scale.
